(19) United States
(12) Patent Application Publication
(10) Pub. No.: US 2006/0035993 A1
(43) Pub. Date: Feb. 16, 2006

(54) Method for preparing a foamable composition and foamed material made from the foamable composition

(75) Inventor: Ming-Kan Chen, Tou-Liu City (TW)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Feng Tay Enterprises Co., LTD

(21) Appl. No.: 10/918,019

(22) Filed: Aug. 13, 2004

(51) Int. Cl. B29C 44/34

(52) U.S. Cl. 521/142

(57) ABSTRACT

A method for preparing a foamable composition includes the steps of: (a) mixing a first portion of polymer particles with a foaming component to obtain a foaming pre-mixture; (b) mixing a second portion of the polymer particles with a crosslinking component to obtain a crosslinking pre-mixture; and (c) mixing the foaming pre-mixture and the crosslinking pre-mixture with a third portion of the polymer particles.

### BACKGROUND OF THE INVENTION

1. Field of the Invention

The invention relates to a method for preparing a foamable composition, more particularly to a method for preparing a foamable composition, which is used for making a foamed material for an intermediate layer of a shoe sole.

2. Description of the Related Art

An outsole of a shoe is usually composed of a lower layer, a middle layer, and an upper layer. The middle layer of the outsole (hereinafter referred to as “midsole”) is used for absorbing the impact imparted on the outsole, and is usually prepared from a polymeric material, such as ethylene-vinyl acetate copolymer. The process for making the midsole includes the steps of kneading, rolling, crushing, pelletizing, drying, injecting, foaming, molding, and stable cooling.

It is necessary to add a crosslinking agent and a foaming agent during the procedure of making the midsole. However, since the morphologies of the polymeric material, the crosslinking agent, and the foaming agent are different, it is difficult to mix these ingredients homogeneously when they are mixed at the same time. Furthermore, an undesirable interfering effect may occur, which will lead to an insufficient reaction. Therefore, it is difficult to achieve desirable physical properties, such as hardness, density, split tear strength, tensile strength, tear strength, elongation, compression set, shrinkage ratio, and others. It is required to add more ingredients including the polymeric material, the crosslinking agent and/or the foaming agent to achieve the desirable physical properties, which increases the manufacturing cost.

As compared to the crosslinking agent and the foaming agent, which are powdery, the polymeric material is composed of polymer particles having a relatively large particle size (>mm). Therefore, the contact areas between the polymeric material and the crosslinking agent as well as the foaming agent are insufficient, which is one of the factors that lead to the heterogeneous mixing.

Additionally, the midsole made by the conventional method has a relatively high density, which means that a relatively high amount of the ingredients is used in the conventional method. Therefore, the cost for the conventional method is relatively high.

### SUMMARY OF THE INVENTION

Therefore, the object of the present invention is to provide a method for preparing a foamable composition for a midsole, which can overcome the aforesaid disadvantages such that the midsole can be made to have desirable physical properties by using the foamable composition.

In the first aspect of this invention, the method for preparing a foamable composition according to this invention includes the steps of: (a) mixing a first portion of polymer particles with a foaming component to obtain a foaming pre-mixture; (b) mixing a second portion of the polymer particles with a crosslinking component to obtain a crosslinking pre-mixture; and (c) mixing the foaming pre-mixture and the crosslinking pre-mixture with a third portion of the polymer particles.

In the second aspect of this invention, a foamed material according to this invention is made from the foamable composition prepared by the method of this invention.

### BRIEF DESCRIPTION OF THE DRAWINGS

Other features and advantages of the present invention will become apparent in the following detailed description of the preferred embodiments with reference to the accompanying drawings, of which:

FIG. 1 is a graph showing a particle size distribution of powdery ethylene-vinyl acetate copolymer used in the examples of this invention;

FIG. 2 is a graph showing a comparison of split tear strength between Example 1 and Comparative Example 1;

FIG. 3 is a graph showing a comparison of split tear strength between Example 2 and Comparative Example 1;

FIG. 4 is a graph showing a comparison of tensile strength between Example 1 and Comparative Example 1;

FIG. 5 is a graph showing a comparison of tensile strength between Example 2 and Comparative Example 1;

FIG. 6 is a graph showing a comparison of elongation between Example 1 and Comparative Example 1;

FIG. 7 is a graph showing a comparison of elongation between Example 2 and Comparative Example 1;

FIG. 8 is a graph showing a comparison of tear strength between Example 1 and Comparative Example 1; and

FIG. 9 is a graph showing a comparison of tear strength between Example 2 and Comparative Example 1.

### DETAILED DESCRIPTION OF THE PREFERRED EMBODIMENTS

In the method for preparing a foamable composition according to this invention, the polymer particles used for preparing the foamable composition are divided beforehand into three portions, i.e., first, second, and third portions. The first portion of the polymer particles is mixed with a foaming component, preferably at room temperature, to obtain a foaming pre-mixture. The second portion of the polymer particles is mixed with a crosslinking component, preferably at room temperature, to obtain a crosslinking pre-mixture. The foaming pre-mixture and the crosslinking pre-mixture are then mixed with the third portion of the polymer particles so as to prepare the foamable composition.

Optionally, the mixing of the foaming pre-mixture and the crosslinking pre-mixture with the third portion of the polymer particles is carried out by premixing, kneading, and rolling. Preferably, the foamable composition can be further processed by crushing and pelletizing for formation into a granular configuration suitable for storage or direct use in a further processing.

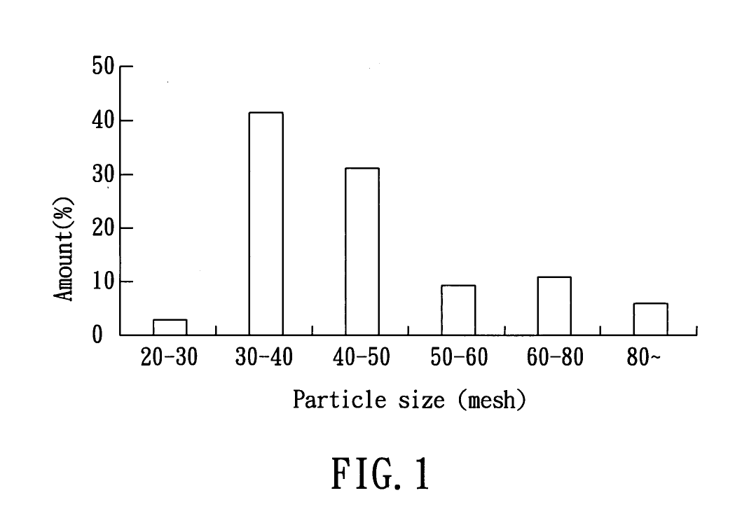

Preferably, with reference to FIG. 1, the polymer particles used in the present invention have a particle size ranging from 16 to 80 mesh (i.e., 1180-180 μm). In the examples, the polymer particles have a particle size ranging from 30-50 μm.

Preferably, the polymer particles are thermoplastic resin. The thermoplastic resin is olefinic polymers and/or olefinic copolymers. Preferably, the thermoplastic resin is polypropylene, polyethylene, ethylene-vinyl acetate copolymer, thermoplastic rubber, ethylene propylene rubber, or mixtures thereof. More preferably, the thermoplastic resin is ethylene-vinyl acetate copolymer. Most preferably, the thermoplastic resin is ethylene-vinyl acetate copolymer including vinyl acetate in an amount ranging from 9 to 40 wt % and having a Melt Index (MI) ranging from 0.5 to 10.0.

Preferably, in the method of this invention, the foaming component is used in an amount ranging from 0.1 to 5 wt %, based on the total weight of the polymer particles. The foaming component useful in the method of this invention varies depending on the specific polymer particles selected, and is well known to those skilled in the art. For example, when ethylene-vinyl acetate copolymer is used as the polymer particles, the foaming component is preferably an azo compound. Preferably, the azo compound is azocarbonamide.

Optionally, the foaming component can include a dispersing additive and an accelerating agent. The dispersing additive used in the examples is Zewa Dis T4 (commercially available from GREAT ZENITH TRADING CO., LTD. or YU TURN ENTERPRISES CO., LTD.), which contains fatty acid and mineral substance. The accelerating agent used in the examples is urea type accelerating agent.

Preferably, the crosslinking component is used in an amount ranging from 0.1 to 5 wt %, based on the total weight of the polymer particles. The crosslinking component useful in the method of this invention varies depending on the specific polymer particles to be crosslinked, and is well known to those skilled in the art. For example, when ethylene-vinyl acetate copolymer is used as the polymer particles, the crosslinking component is preferably a peroxide compound. Preferably, the peroxide compound is dicumyl peroxide.

Preferably, the method of this invention can include a step of adding an additive to the third portion of the polymer particles to obtain an additive pre-mixture, which is then mixed with the foaming pre-mixture and the crosslinking pre-mixture. The additive useful in the method of this invention is well known to those skilled in the art, and can include a filler, a dispersing agent, a coupling agent, zinc oxide, and titanium oxide.

Optionally, the mixing of the third portion of the polymer particles with the foaming pre-mixture and the crosslinking pre-mixture is carried out by pre-mixing, kneading, and rolling. Preferably, the kneading is conducted at a temperature not higher than 100° C.

Preferably, the method of this invention further includes steps of forming the foamable composition into a sheet, and crushing and pelletizing the sheet.

In another aspect, this invention provides a foamed material, which is made from the foamable composition prepared by the method of this invention.

In a further aspect, this invention provides a method for making a midsole, which includes a step of processing the foamable composition by injecting, foaming and molding so as to make the midsole having a predetermined shape.

Optionally, the method for making the midsole includes a step of pre-treating the foamable composition by drying. Additionally, in order to control the size of the midsole, the midsole thus-produced is further processed by setting at a constant temperature.

The following examples are provided to illustrate the preferred embodiments of the invention, and should not be construed as limiting the scope of the invention.

### EXAMPLES

Chemicals:

(i) Polymer Particles:

The polymer particles used in the following examples and comparative example are particles of ethylene-vinyl acetate (hereinafter referred to as “EVA particles”) which includes vinyl acetate in an amount of 22 wt %, and has a Melt Index (MI) of 2.5.

In order to demonstrate that the small particle size of the polymer particles can improve the mixing homogeneity of the foamable composition, which in turn improves the physical properties of the midsole made therefrom, the commercially available EVA particles, which have an average particle size of about 4 mm, are ground into those having an average particle size 50 mesh in view of the fact that the commercially available pigments and additives usually have a particle size of about 50 mesh. The particle size distribution of the ground EVA particles is shown in FIG. 1, in which the majority of the ground EVA particles has a particle size ranging from 30 to 50 mesh. The ground EVA particles will be referred to as powdery EVA particles hereinafter. In the following examples and comparative example, the powdery EVA particles and the commercially available EVA particles are used for comparison.

(ii) Foaming Component:

Based on 100 parts by weight of powdery EVA particles, the foaming component used in the examples is composed of 2.70 parts by weight of azocarbonamide, 1.00 part by weight of Zewa Dis T4, and 0.70 part by weight of urea type accelerating agent.

(iii) Crosslinking Component:

Based on 100 parts by weight of powdery EVA particles, the crosslinking component used in the examples is composed of 0.68 part by weight of dicumyl peroxide.

(iv) Additives:

Based on 100 parts by weight of powdery EVA particles, the additives used in the examples include the following:

| | Amount |
|---|---|
| Compound | Part(s) |
| Zinc oxide | 1.00 |
| Dispersing agent | 1.00 |
| Filler (Magnesium carbonate) | 10.00 |
| Titanium oxide | 1.50 |
| Coupling agent (isopropyl | 0.60 |
| tri-isostearoyl titanate) | |

Tests for Physical Properties:

The midsole made in each of the examples and the comparative example is tested for its physical properties by the following methods:
1. Hardness (unit: Asker C): Tested according to ASTM D-2240 Standard Test Method.
2. Density (unit: g/ml): Tested according to ASTM D-297 Standard Test Method.
3. Split tear strength (unit: kg/cm²): Tested according to ASTM D-3574 Standard Test Method. The midsole possesses a better split tear strength when the tested value is more than 2.5 kg/cm².
4. Tensile strength (unit: kg/cm²): Tested according to ASTM-D-412 Standard Test Method. The midsole possesses a better tensile strength when the tested value is more than 20 kg/cm².
5. Tear strength (unit: kg/cm): Tested according to ASTM-D-624 Standard Test Method. The midsole possesses a better tear strength when the tested value is more than 10 kg/cm.
6. Elongation (unit: %): Tested according to ASTM-D-412 Standard Test Method. The midsole possesses a better elongation when the tested value is between 200 to 400%.
7. Compression set (unit: %): Tested according to NIKE-16

Standard Test Method described as follows:
(I) Obtaining a test specimen from the midsole by using a circular rotary blade;
(II) Measuring a thickness of a center position of the test specimen to obtain an initial thickness of the test specimen (Ti);
(III) Mounting the test specimen between two separators inacompression device (manufactured by FENG TAY ENTERPRISES CO., LTD.) immediately after raising the compression device to a temperature of 50° C., the thickness of each of the separators (Tₛ) being half of the initial thickness of the test specimen, compressing the test specimen while avoiding contact of the test specimen with the separators, and letting the compression device having the test specimen therein stand in a constant temperature oven for 6 hours;
(IV) Removing the test specimen from the compression device and letting it stand at room temperature for 30 minutes, followed by measuring the thickness of the compressed test specimen (T_{c}); and
(V) Calculating the compression set using the following formula:

$$Compression set \% = \frac{{T}_{i} - {T}_{c}}{{T}_{i} - {T}_{s}} \times 100 \%$$

The midsole possesses a better compression set when the tested value is smaller than 60%.
8. Shrinkage ratio (unit:%): Tested according to NIKE-1

Standard Test Method described as follows:
(I) Obtaining a test specimen (size=15 cm×15 cm; thickness=about 10 mm), marking a cross at a center of the test specimen, measuring length of one line segment of the cross, and recording the measured length as an initial length (Lᵢ);
(II) Mounting the test specimen in a shrinkage device (manufactured by FENG TAY ENTERPRISES CO., LTD.) for 20 minutes immediately after raising the shrinkage device to a temperature of 70° C.;
(III) Removing the shrunken test specimen from the shrinkage device, letting it stand at room temperature for 30 minutes, and measuring the length of the line segment to obtain a shrunken length (Lₛ); and

(IV) Calculating the shrinkage ratio using the following formula:

$$Shrinkage ratio \% = \frac{{L}_{i} - {L}_{s}}{{L}_{i}} \times 100 \%$$

The midsole possesses a better shrinkage ratio when the tested value is smaller than 2%.

### Example 1

1. Preparation of foamable composition:
(a) dividing 100 parts by weight (pbw) of the commercially available EVA particles into first, second and third portions, which have 30 pbw, 30 pbw, and 40 pbw, respectively;
(al) mixing the additives (iv) with the third portion of the EVA particles at room temperature to obtain an additive pre-mixture;
(b) mixing the foaming component (ii) with the first portion of the EVA particles at room temperature to obtain a foaming pre-mixture;
(c) mixing the crosslinking component (iii) with the second portion of the EVA particles at room temperature to obtain a crosslinking pre-mixture;
(d) premixing the additive pre-mixture from the step (a1) with the foaming pre-mixture from the step (b) and the crosslinking component from the step (c) to obtain a mixture, which is further processed by kneading in a kneader at a temperature of up to 100° C. for 5-7 minutes followed by rolling in a roller at a temperature of about 60° C. so as to obtain the foamable composition;
(e) forming the foamable composition into a sheet having a thickness of 2 mm; and
(f) further processing the sheet by crushing in a crusher followed by pelletizing in a mono-screw pelletizer at a temperature of about 80-85° C. so as to obtain a particulate foamable composition.

2. Preparation of a midole:
(g) drying the particulate foamable composition at a temperature of 40° C. to obtain a dried particulate foamable composition;
(h) injecting, foaming and molding the dried particulate foamable composition at a temperature of 165° C. to result in the midsole having a predetermined shape; and
(i) setting the midsole by letting it stand at 60° C., 50° C. and 40° C. sequentially for a total time of 40 minutes so as to obtain the midsole having an accurate size.

The physical properties of the midsole prepared thereby are shown in the following Table 1.

### Example 2

This example is carried out by following the procedure identical to that of Example 1, except of using the powdery EVA particles having a particle size of 30-50 mesh. The physical properties of the midsole prepared thereby are also shown in the following Table 1.

### Comparative Example 1

The comparative example is carried out by following the procedure identical to that of Example 1, except the commercially available EVA particles, the foaming component, the crosslinking component, and the additives are mixed simultaneously. The physical properties of the midsole prepared there by are also shown in the following Table 1.

TABLE 1

| | | | | | Split tear | Tensile | | Tear |
|---|---|---|---|---|---|---|---|---|
| | Hardness | Density | Compression | Shrinkage | strength | Strength | Elongation | strength |
| | (Asker C) | (g/ml) | set (%) | ratio (%) | (kg/cm²) | (kg/cm²) | (%) | (kg/m) |
| Ex. 1 | 44-45 | 0.1691 | 55 | 0.3 | 3.2 | 34 | 374 | 10 |
| | 44-45 | 0.1704 | 55 | | 3.4 | 33 | 361 | 10 |
| | | | | | 3.3 | 31 | 367 | 11 |
| | | | | | 3.3 | 35 | 369 | 9 |
| | | | | | 3.3 | 31 | 351 | 10 |
| | | | | | 3.3 | 32 | 364 | 11 |
| Ex. 2 | 43-44 | 0.1644 | 56 | 0.2 | 3.3 | 30 | 362 | 12 |
| | 43-44 | 0.1620 | 60 | | 3.3 | 29 | 362 | 10 |
| | | | | | 3.3 | 32 | 351 | 10 |
| | | | | | 3.3 | 29 | 354 | 10 |
| | | | | | 3.4 | 31 | 359 | 9 |
| | | | | | 3.3 | 26 | 331 | 9 |
| Com. 1 | 44-46 | 0.1727 | 54 | 0.5 | 3.3 | 34 | 370 | 10 |
| | 44-45 | 0.1709 | 48 | | 3.1 | 35 | 368 | 11 |
| | | | | | 3.1 | 30 | 360 | 9 |
| | | | | | 3.5 | 31 | 360 | 9 |
| | | | | | 3.6 | 31 | 364 | 10 |
| | | | | | 3.1 | 29 | 332 | 11 |

Test Results:
Hardness, Density and Compression Set:

As shown in Table 1, as compared to Comparative Example 1, the density of the midsole prepared in Example 1 is relatively small, which means that the amounts of the ingredients for preparing the midsole are reduced. Therefore, the cost for preparing the midsole can be reduced. Furthermore, the hardness and the compression set of each of the midsole of Examples 1 and 2 are also better than those regulated in the aforesaid physical property standard.

Split Tear Strength, Tensile Strength, Elongation, and Tear Strength:

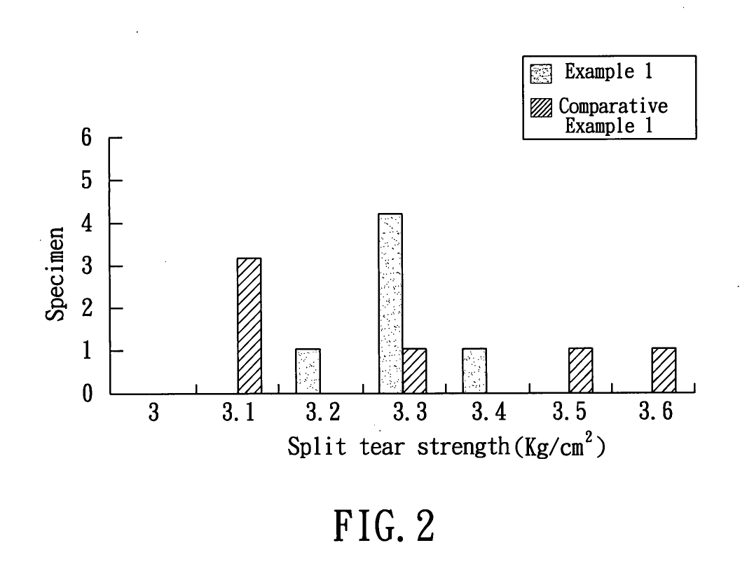

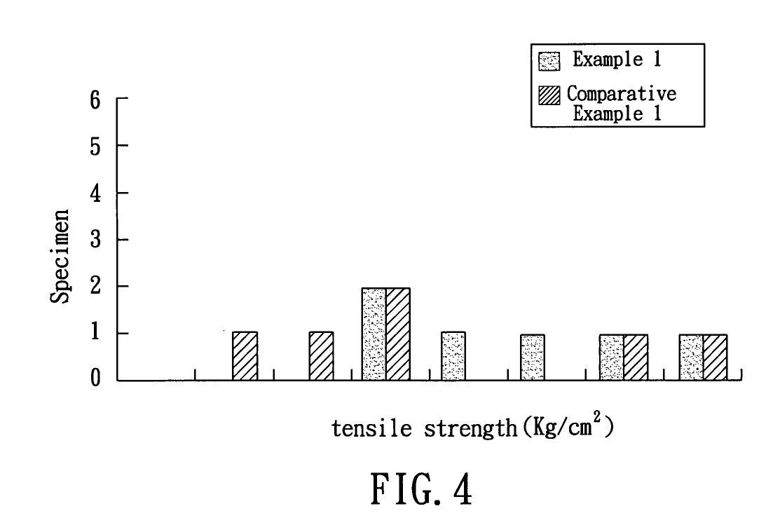

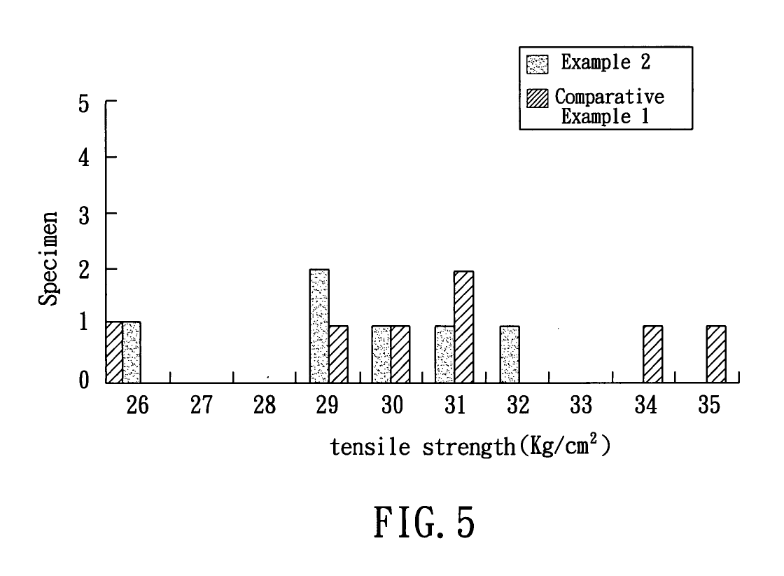

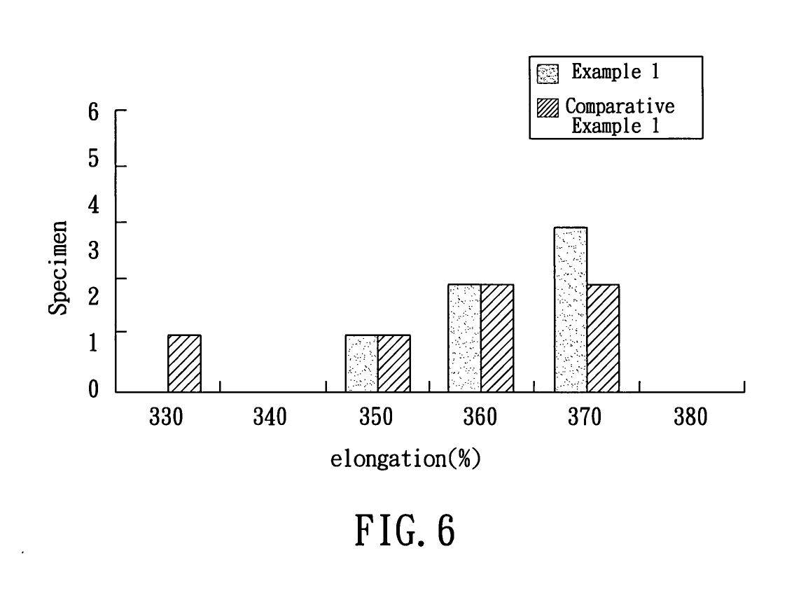

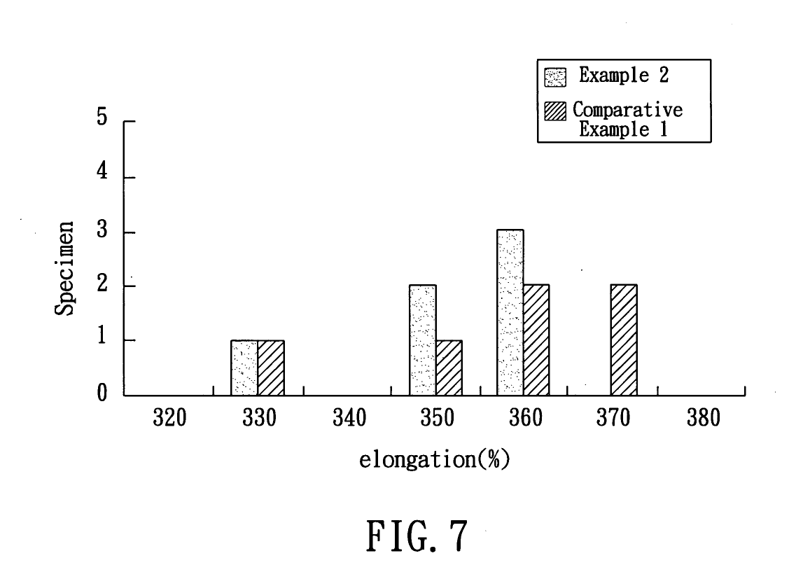

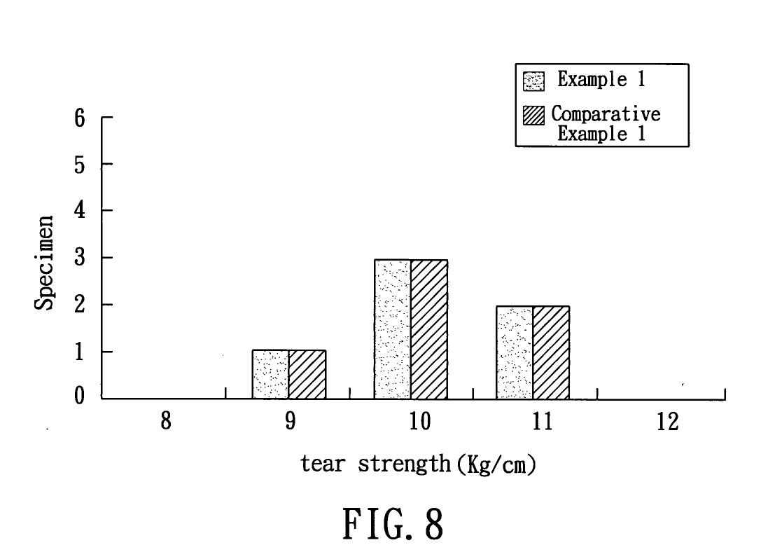

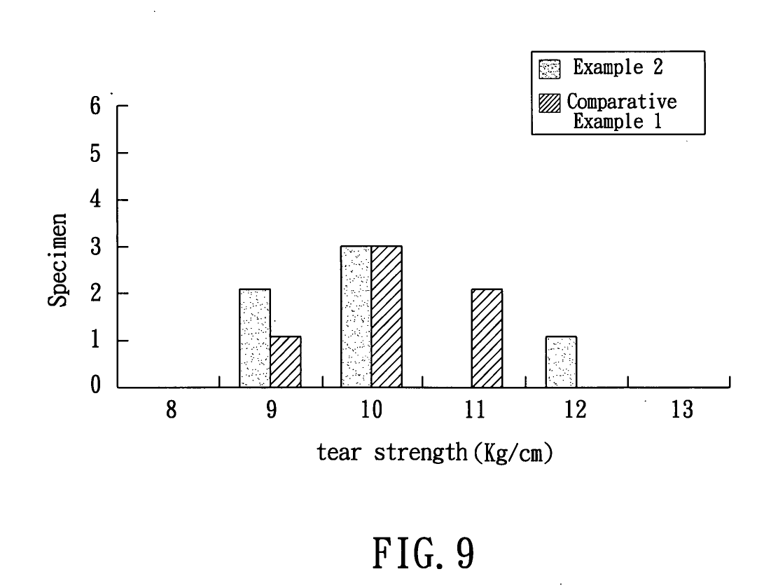

As shown in FIGS. 2-9, the tested values of Examples 1 and 2 are relatively concentrated as compared to those of Comparative Example 1, which means that the homogeneity of the foamable compositions of Examples 1 and 2 is improved. Additionally, the physical properties determined in Examples 1 and 2 may be inferior to those determined in Comparative Example 1 (such as, the tensile strength shown in FIG. 5), which means that over curing phenomenon occurred in the examples when Examples 1 and 2 and Comparative Example 1 are conducted under the same conditions. Therefore, the cycle time for obtaining the midsole having the physical properties comparable to those of the midsole of Comparative Example 1 can be reduced in this invention.

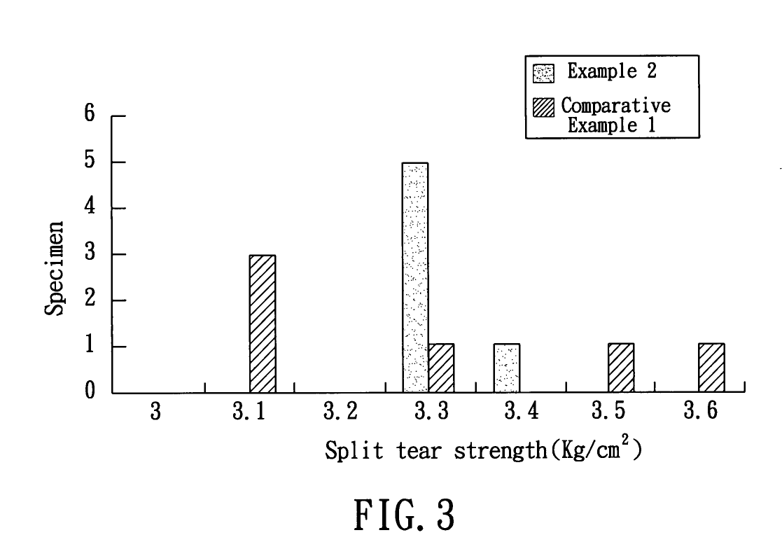

Furthermore, as shown in FIGS. 3, 5, 7, and 9, the values determined in Example 2 are more concentrated as compared to those determined in Comparative Example 1, which means that the physical properties of the midsole can be further improved by using the powdery EVA particles having a relatively small particle size (such as, 30-50 mesh) in a manner of sequential mixing processing.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for preparing a foamable composition, comprising the steps of:
(a) mixing a first portion of polymer particles with a foaming component to obtain a foaming pre-mixture;
(b) mixing a second portion of said polymer particles with a crosslinking component to obtain a crosslinking pre-mixture; and
(c) mixing said foaming pre-mixture and said crosslinking pre-mixture with a third portion of said polymer particles.

2. The method as claimed in claim 1, wherein step (a) is carried out at room temperature.

3. The method as claimed in claim 1, wherein step (b) is carried out at room temperature.

4. The method as claimed in claim 1, wherein said polymer particles have a particle size ranging from 16 to 80 mesh.

5. The method as claimed in claim 1, wherein said polymer particles are thermoplastic resin.

6. The method as claimed in claim 5, wherein said thermoplastic resin is selected from a group consisting of olefinic polymers and olefinic copolymers.

7. The method as claimed in claim 5, wherein said thermoplastic resin is selected from a group consisting of polypropylene, polyethylene, ethylene-vinyl acetate copolymer, thermoplastic rubber, and ethylene propylene rubber.

8. The method as claimed in claim 7, wherein said thermoplastic resin is ethylene-vinyl acetate copolymer.

9. The method as claimed in claim 8, wherein said ethylene-vinyl acetate copolymer includes vinyl acetate in an amount ranging from 9 to 40 wt %, and has a flow index ranging from 0.5 to 10.0.

10. The method as claimed in claim 1, wherein said foaming component is used in an amount ranging from 0.1 to 5 wt %, based on the total weight of said polymer particles.

11. The method as claimed in claim 1, wherein said foaming component includes an azo compound.

12. The method as claimed in claim 11, wherein said azo compound is azocarbonamide.

13. The method as claimed in claim 1, wherein said crosslinking component is used in an amount ranging from 0.1 to 5 wt %, based on the total weight of said polymer particles.

14. The method as claimed in claim 1, wherein said crosslinking component includes a peroxide compound.

15. The method as claimed in claim 1, wherein said peroxide compound is dicumyl peroxide.

16. The method as claimed in claim 1, further comprising a step of adding an additive.

17. The method as claimed in claim 16, wherein said additive is selected from a group consisting of a filler, a dispersing agent, a coupling agent, zinc oxide, and titanium oxide.

18. A foamed material made from a foamable composition prepared by the method of claim 1.
